(19) United States
(12) Patent Application Publication
(10) Pub. No.: US 2008/0136384 A1
(43) Pub. Date: Jun. 12, 2008

(54) CAPACITOR-FREE LINEAR VOLTAGE REGULATOR FOR INTEGRATED CONTROLLER AREA NETWORK TRANSCEIVERS

(75) Inventors: Mohammad A Al-Shyoukh, Richardson, TX (US); Kannan Soundarapandian, Dallas, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS, INCORPORATED, Dallas, TX (US)

(21) Appl. No.: 11/567,462

(22) Filed: Dec. 6, 2006

(51) Int. Cl. G05F 1/00

(52) U.S. Cl. 323/273

(57) ABSTRACT

A voltage regulator circuit for a CAN transceiver has a preregulator circuit which reduces an input voltage to a maximum predetermined voltage. The preregulator circuit is built with diffused MOS (DMOS) or drain extended MOS (DEMOS) transistors or laterally diffused MOS (LDMOS) transistors that are usable with the higher input voltages. A main regulator is coupled to the preregulated voltage to generate the output voltage. The main regulator utilizes lower voltage but faster core transistors and is stable without a load capacitance.

### TECHNICAL FIELD OF THE INVENTION

This invention relates to a voltage regulation circuit for an integrated controller area network (CAN) transceiver and more specifically to a voltage regulator that is both operable and stable if the output capacitor of the regulator, which is normally external to the regulator, is disconnected.

### BACKGROUND OF THE INVENTION

Modern vehicles have abandoned the utilization of separate wires between the various modules on the vehicle because of the sheer bulk of the number of conductors required and the cost associated therewith. The main motivation for using a CAN bus is noise immunity. It is used widely in automobiles, as well as industrial applications where the environment is harsh and levels of electrical interference are very high. These vehicles use a controller area network (CAN) in accordance with International Standard ISO 11898, entitled “Road vehicle-Interchange of digital information—Controller area network (CAN) for high-speed communication”, for example.

Recent trends in integrated circuits for automotive CAN systems call for the integration of more and more functions and modules on to the same integrated circuit to constitute a large System-on-Chip (SoC) application. This mass integration is meant to reduce the cost and improve the reliability of a comparable discrete-component system. Each of these SoC systems will have a transceiver associated therewith. One important module that such integrated SoC CAN transceivers require is a linear voltage regulator to enable direct operation from the car battery. These modules, as demanded by the CAN ISO standard, run from a 5V supply. Automotive batteries are normally 12V, although newer electrical systems will operate from battery voltages as high as 40V. Accordingly, the on-chip voltage regulator must be able to handle a 40V input and still allow direct operation from the car battery down to 5.5V.

Stringent requirements on the reliability for integrated circuits for use in automobiles require that such devices have minimal dependence on external components. Having an external capacitor between the regulated voltage and the system reference provides for a more efficient regulator and is commonly used. Regulators built to operate with this external capacitor are often unstable if the capacitor should become disconnected by a fault in the system or failure, thus rendering the module inoperative. This renders the entire SoC system inoperative, and thus fails to meet industry reliability requirements. CAN transceivers are made up with the CAN receivers and CAN drivers. A CAN receiver typically consumes low current and simply receives digital data which is transmitted over the CAN bus and converts it from the CAN bus thresholds for transmitting digital data to regular high/low digital format, that is, the high being equal to the supply voltage and the low being equal to the ground. A CAN driver on the other hand takes a stream of digital bits and transmits them on the CAN bus according to the CAN protocol for transmitting digital data. The CAN protocol transmits a differential signal on the CANH and the CANL lines of the CAN bus. In the dominant state, which corresponds to a logic 0, the CANH line is higher than the CANL line by differential voltage V_{d} such that V_{canh}=V_{cm}+V_{d}/2 and V_{canl}=V_{cm}−V_{d}/2, where V_{cm} is the common mode voltage. The recessive state, which corresponds to the transmission of a digital 1, has both the CANH and CANL lines at the same potential V_{cm} such that the differential voltage between them V_{d} is equal to 0. A transition to the dominant state constitutes the transmission of a logic 0 bit and can involve the switching of currents up to 80 mA into the CAN bus.

In order to handle the transition from the recessive state to the dominant state which involves the switching of this large current, the regulator circuit must have a fast transient response. However, semiconductor devices able to withstand the possible 40V input are too slow to provide the needed transient response. Furthermore, the design must be fault tolerant so that it is able to operate without the external capacitor, and without requiring additional fault monitoring diagnostic circuitry in the system to check that the that the external component did not go bad or become disconnected. It would therefore be desirable to have a regulator circuit which could provide all three of these features simultaneously.

### SUMMARY OF THE INVENTION

It is a general object of the present invention to provide a voltage regulation circuit for a CAN transceiver that is stable and operable without an output capacitor.

This and other objects and features of the present invention are provided by a voltage regulator circuit for a CAN transceiver comprising a pre-regulator circuit reducing an input voltage to a maximum predetermined voltage. The pre-regulator circuit comprises slower, higher breakdown voltage transistors. A main regulator coupled to the pre-regulated voltage to generate an output voltage. The main regulator comprises faster, lower breakdown voltage transistors, so that the main regulator is stable without a load capacitance.

Another aspect of the present invention includes a voltage regulator circuit for a CAN transceiver having a pre-regulator circuit reducing an input voltage to a maximum predetermined voltage. The pre-regulator circuit includes a drive voltage circuit generating a drive voltage for a pass transistor by providing a reference voltage generator for generating a reference voltage that is a submultiple M of the drive voltage, and a voltage multiplier that multiplies the reference voltage by 1/M to generate the drive voltage. A main regulator is coupled to the pre-regulated voltage to generate an output voltage and comprises a low dropout (LDO) buffer/regulator having a current mode error amplifier driving a power transistor.

### BRIEF DESCRIPTION OF THE DRAWINGS

FIG. 1 is a block diagram of a voltage regulator circuit and CAN transceiver module on an integrated circuit;

FIG. 2 is a schematic block diagram of the drive module 112 of FIG. 1;

FIG. 3 is a schematic diagram of a known main regulator core 114; and

FIG. 4 is a schematic diagram of the main regulator core of FIG. 3 modified for the present invention.

### DETAILED DESCRIPTION

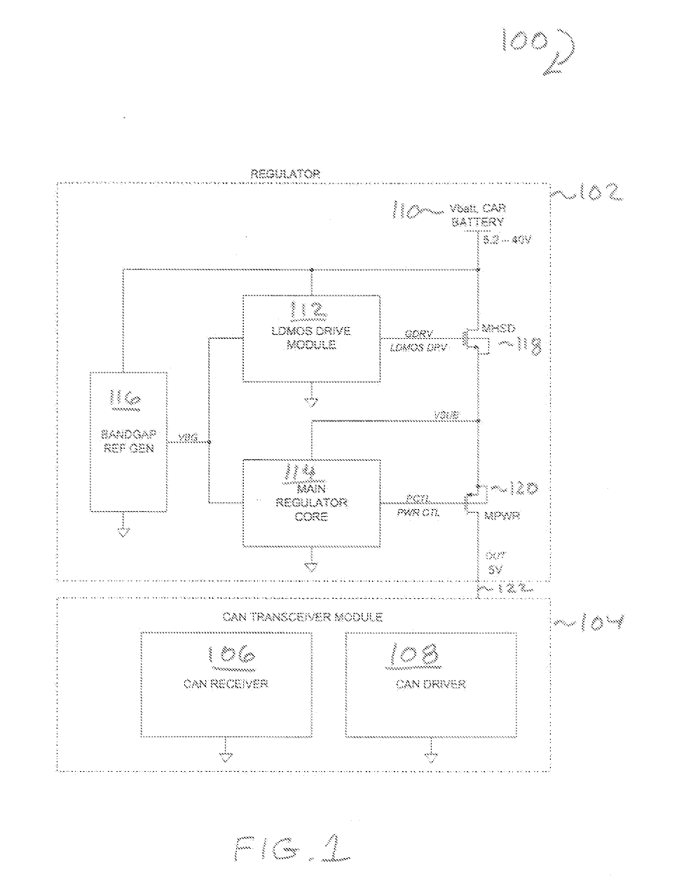

Referring now to FIG. 1, a block diagram of the present invention is shown generally as 100. This circuit comprises a regulator circuit 102 and a CAN transceiver module 104, which are coupled to a car battery voltage source 110 which can vary between 5.2 and 40 volts. The regulator module 102 comprises a pre-regulator circuit including a drive module 112, pass transistor 118 and bandgap reference voltage source 116. The regulator module 102 comprises main regulator core 114 and pass transistor 120. The output voltage of the regulator module 102 on line 122 is 5V, as dictated by the CAN ISO standard, to CAN transceiver module 104. Transceiver module 104 comprises a CAN receiver circuit 106 and a CAN driver circuit 108, as is well known to those skilled in the art.

The voltage from the car battery passes through the pre-regulator circuit which limits the voltage to 12V. The value for this limit is technology and design dependent and other values can be chosen. This circuitry is built utilizing laterally defused MOS (LDMOS) devices, which can withstand the 40V input that may be utilized by some automotive systems. Other diffused MOS (DMOS) or drain extended MOS (DEMOS) transistors can also be used. The car battery voltage 110 is applied to a bandgap reference voltage 116 which produces an output VBG to the drive module 112. Drive module 112 produces a voltage at the gate of a pass transistor 118 which is also built using LDMOS technology, so that it can handle the potentially high car battery voltage. Other diffused MOS (DMOS) or drain extended MOS (DEMOS) structures can also be utilized for pass transistor 118. If the voltage at the gate of transistor 118 is limited to 12V for example, then the voltage at the source of transistor 118 will be a maximum of 12V minus the Vₜ of transistor 118. Thus, in no circumstance can this voltage exceed 12V, so that the main regulator core 114, and pass transistor 120 can be build utilizing low voltage, higher speed (core) MOS devices. It should also be noted that in accordance with an aspect of the invention pass transistor 118 is used in a source follower configuration to maximize the speed realized out of the inherently slow high voltage LDMOS or DEMOS structure used to realize the device.

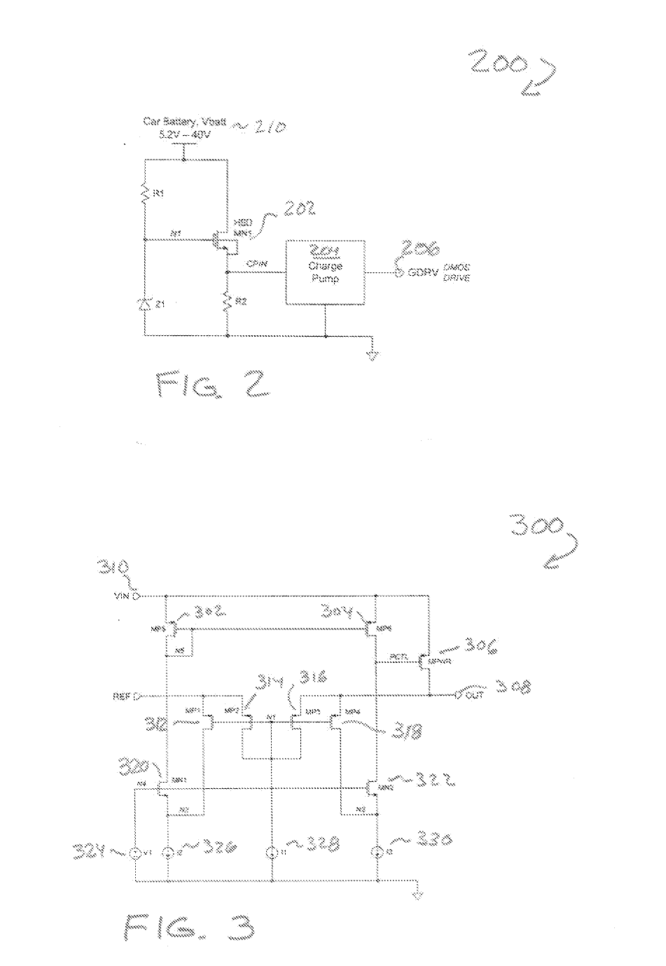

FIG. 2 illustrates an alternative embodiment of the pre-regulator circuit drive module 112, generally as 200. This alternative circuit utilizes a zener diode reference instead of a band gap reference coupled to an operational amplifier or other well known band gap reference voltage circuit. The zener diode circuit is generally a lower cost, less accurate, alternative to the band gap reference. In FIG. 2 a zener diode Z1 is coupled in a series with a resistor R1 between the battery voltage 210 and ground. An LDMOS transistor 202 has its drain connected to the battery voltage and its source connected to ground via resistor R2. The gate of transistor 202 is connected to junction of resistor R1 and zener diode Z1. If a 6V zener diode is utilized, for example, then the output voltage of the source of transistor 202, across resistor R2, will be approximately 6V minus the Vₜ of transistor 202. This voltage is input to charge pump 204, which may be a voltage doubler, for example, to produce an output voltage of almost 12V on Line 206. The particular type of charge pump 204 that is utilized is not important, because the output current on Line 206 only needs to be sufficient to drive the gate of transistor 118, which is essentially capacitive and requires very little current. If a voltage of almost 12V is output on Line 206, then the voltage at the source of transistor 118 will be almost 12V less the Vₜ of transistor 118 at light load conditions for the regulator. At heavy load conditions the source voltage of transistor 118 will drop sufficiently enough below 12V−Vₜ to allow for the conduction of the extra current through the additional gate-source drive V_{gs} realized. Transistor 118 is therefore sized such that the minimum voltage at the source of that transistor exceeds 5V at all operating conditions to allow enough headroom for the main regulator to further regulate down to 5V. In this circuit, for high car battery voltages, the pass transistor 118 will be in the saturation region as its drain-source voltage (V_{ds}) would be well above its gate-source voltage less Vₜ (V_{gs}−Vₜ). As the battery voltage gets lower and lower and goes below the gate voltage of pass transistor 118, the source of that transistor would start getting lower and lower and the transistor goes into the linear region with a higher voltage drop between its gate and its source. Therefore, the gate drive voltage and size of transistor 118 must be chosen such that the minimum voltage seen at the source of that transistor is greater than 5V, and such that the maximum voltage seen at the source of that transistor (V_{g}−Vₜ approximately at 12V−Vₜ) is less than the maximum voltage rating for the low voltage components utilized in that portion of the regulation circuit. For lower car battery voltages, i.e. 5.2V, the pass transistor 118 will be driven so deep into a linear region and will have a very low dropout across it such that source voltage of the transistor will simply follow its drain and be at approximately the same voltage as the drain voltage.

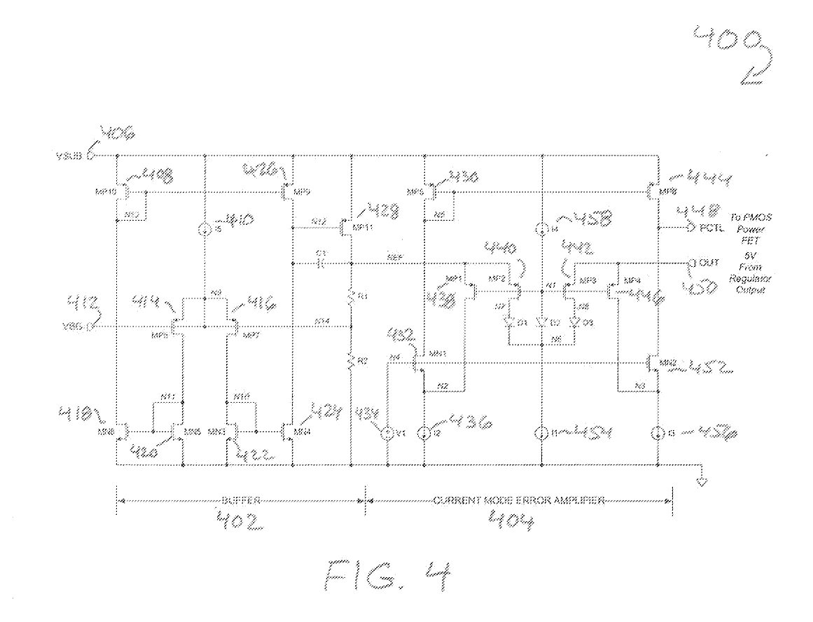

FIG. 3 shows a prior art circuit that can be utilized for the main regulator core 114 generally as 300. More information on the circuit can be found in a commonly-assigned U.S. Pat. No. 6,703,815 of Hubert J. Biagi, which is incorporated herein by reference in its entirety. In FIG. 3 the input voltage is connected to terminal 310 which is connected to the source of PMOS transistor 302, which is connected as a diode by shorting the gate thereof to the drain thereof. A second PMOS transistor 304 has its source connected to the source of input voltage 310 and its gate connected to the gate of transistor 302. A third PMOS transistor 306 has its source connected to the voltage source 310 and its gate connected to the drain of transistor 304. The drain of transistor 306 is connected to the output 308 of the circuit. PMOS transistors 316 and 318 have their sources connected to the output voltage 308. The drain of transistors 304 is connected to the drain of NMOS transistor 322, the source of which is connected to the drain of transistor 318 and to a current source 330 the other terminal which is connected to ground. The sources of the two PMOS transistors 312 and 314 are connected to the bandgap reference voltage generator by circuit 116 in FIG. 1. Any of the well known bandgap reference circuits can be used to provide the reference voltage VBG at the output of circuit 116. The gates of transistors 312, 314, 316, and 318 are connected together and connected to the drains of transistors 314 and 316, which are then connected via current source 328 to ground. The drain of transistor 302 is connected to the drain of NMOS transistor 320, the source of which is connected to the drain of transistor 312 and is coupled to ground through current source 326. The gate of transistor 320 is coupled to voltage source 324, the other terminal which is coupled to ground. The circuit shown in FIG. 3 is a current mode error amplifier driving the PMOS pass transistor 120 to generate the 5.0V output. This circuit requires a buffer to create the reference voltage REF at a low enough output impedance to drive the low impedance input to the error amplifier, and has good transient behavior due to the fast current-mode input stage. In order to avoid charging the large capacitance C_{gs} and the Miller-gained C_{gd} capacitance through the high impedance mode PCTL (at the gate of transistor 306), the current through current sources 326 and 330 are increased to speed up the large signal and small signal responses and to lower the impedance at the PCTL node.

FIG. 4 shows the complete structure of the regulator core 114 generally as 400. In FIG. 4, the buffer 402 is shown as well as the current mode error amplifier 404. The pre-regulated voltage at terminal 406 is coupled to the sources of PMOS transistors 408, 426, 430 and 444. This voltage is also coupled via current source 410 to the sources of PMOS transistors 414 and 416, the substrates of which are connected together and connected to the sources thereof. The pre-regulated voltage at terminal 406 is also coupled to the gates of PMOS transistors 440 and 442, through current source 458. The gates of transistors 440 and 442 are connected together. The gate of transistor 408 is connected to the drain thereof so that it is a diode-connected transistor, as is transistor 430. The drain of transistor 408 is connected to the drain of NMOS transistor 418, the source thereof being connected to ground. The bandgap reference voltage generated by circuit 116 is connected to terminal 412, which is connected to the gate of transistor 414. The drain of transistor 414 is connected to diode-connected to NMOS transistor 420, the source of which is connected to ground. The drain of transistor 416 is connected to diode-connected NMOS transistor 422, the source of which is connected to ground. The source of PMOS transistor 428 is connected to the pre-regulated voltage 406 the gate thereof is connected to the drain of transistor 426. The drain of transistor 428 is connected to one terminal of resistor R1 which is in a series with resistor R2 to ground. A capacitor C1 is connected between the drains of transistors 426 and 428. The junction of resistors R1 and R2 is connected to the gate of transistor 416. The drain of transistor 426 is connected to the drain of NMOS transistor 424, the source of which is connected to ground. The gate of transistor 424 is connected to the gate of diode-connected transistor 422. The drain of transistor 430 is connected to the drain of NMOS transistor 432, the source of which is connected to ground through current source 436 and connected to the drain of PMOS transistor 438. The gate of transistor 432 is connected to ground via voltage source 434. The source of transistor 438 is connected to the drain of transistor 428 and the gates of transistor 438, 440, 442, and 446 are connected together and to the pre-regulated voltage source 406 through current source 458. The source of PMOS transistor 440 is connected to the source of PMOS transistor 438 and the drain of transistor 428. The source of PMOS transistor 442 and of PMOS transistor 446 are connected to output voltage 450. The drains of transistors 440 and 442 are connected to the gates thereof and the connected gates are connected via diode D2 to one terminal of current source 454, the other terminal of which is connected to ground. The drains of transistors 440 and 442 are connected to the one terminal of current source 454 via diodes D1 and D3, respectively. The drain of PMOS transistor 444 is connected to the drain of NMOS transistor 452, the source of which is connected to ground through current source 456, and its gate is connected to the connected gates of transistors 440, 442. The drain of transistor 446 is connected to the source of transistor 452, which is coupled to ground via current source 456. The source of transistor 444 is connected to the gate of pass transistor 120 in FIG. 1.

The buffer 402 required to drive the reference node has been implemented using a simple folded operational transconductanc amplifier (OTA) with a class A output stage. Those skilled in the art will recognize that other implementations are possible for this buffer circuit. In the current mode amplifier 404, diodes D1, D2, and D3 block the DC path between the reference node 412 and the output node 450 which help to improve start-up time considerably. In addition, this DC path can cause the buffer driving the reference node to become unstable if it loads the reference node significantly. This regulator core can control the transistor 120 to regulate the voltage at the output of transistor 118 down to desired voltage. This circuit can maintain regulation at a very low dropout value and still provide a 5.0V output with a 5.2V battery input voltage at terminal 110. If the current sources 13 and 12 are made sufficiently high to reduce the impedance seen at node PCTL, the no load to full load transient condition would result in a small dip in the regulator output voltage, which enables the operation of the circuit without the presence of the external capacitor. This is due to the fact that increasing current sources 13 and 12 would reduce the small signal impedance seen at node PCTL, and would make larger current available for large signal slewing, resulting in faster control of node PCTL driving power FET 120, which improves transient response overall.

While the invention has been shown and described with reference to preferred embodiments thereof, it is well understood by those skilled in the art that various changes and modifications can be made in the invention without departing from the spirit and scope of the invention as defined by the appended claims.

1. A voltage regulator circuit for a CAN transceiver comprising:
a preregulator circuit reducing an input voltage to a maximum predetermined voltage, the preregulator circuit comprising diffused MOS (DMOS) or drain extended MOS (DEMOS) transistors:
a main regulator coupled to the preregulated voltage to generate an output voltage, the main regulator comprising core transistors, wherein the main regulator is stable without a load capacitance.

2. The voltage regulator of claim 1 wherein the preregulator circuit comprises:
A drive voltage circuit generating a drive voltage for a pass transistor that is equal to the maximum predetermined voltage plus Vₜ of the pass transistor.

3. The voltage regulator of claim 2 wherein the drive voltage circuit comprises:
a reference voltage generator for generating a reference voltage that is a submultiple M of the drive voltage; and
a voltage multiplier that multiplies the reference voltage by 1/M to generate the drive voltage.

4. The voltage regulator of claim 2 wherein the preregulator circuit drive circuit and pass transistor are formed with LDMOS transistors, and wherein the pass transistor is used in a source-follower configuration.

5. The voltage regulator of claim 3 wherein the preregulator circuit drive circuit and pass transistor are formed with LDMOS transistors, and wherein the pass transistor is used in a source follower configuration.

6. The voltage regulator circuit of claim 1 wherein the main regulator circuit comprises:
a low dropout (LDO) buffer/regulator having a current mode error amplifier driving a power transistor.

7. The voltage regulator of claim 6 wherein the power transistor is a PMOS transistor.

8. The voltage regulator circuit of claim 2 wherein the main regulator circuit comprises:
a low dropout (LDO) buffer/regulator having a current mode error amplifier driving a power transistor.

9. The voltage regulator of claim 8 wherein the power transistor is a PMOS transistor.

10. The voltage regulator circuit of claim 3 wherein the main regulator circuit comprises:
a low dropout (LDO) buffer/regulator having a current mode error amplifier driving a power transistor.

11. The voltage regulator of claim 10 wherein the power transistor is a PMOS transistor.

12. The voltage regulator circuit of claim 4 wherein the main regulator circuit comprises:
a low dropout (LDO) buffer/regulator having a current mode error amplifier driving a power transistor.

13. The voltage regulator of claim 12 wherein the power transistor is a PMOS transistor.

14. The voltage regulator circuit of claim 5 wherein the main regulator circuit comprises:
a low dropout (LDO) buffer/regulator having a current mode error amplifier driving a power transistor.

15. The voltage regulator of claim 14 wherein the power transistor is a PMOS transistor.

16. A voltage regulator circuit for a CAN transceiver comprising:
a preregulator circuit reducing an input voltage to a maximum predetermined voltage and comprising a drive voltage circuit generating a drive voltage for a pass transistor by providing a reference voltage generator for generating a reference voltage that is a submultiple M of the drive voltage, and a voltage multiplier that multiplies the reference voltage by 1/M to generate the drive voltage; and
a main regulator coupled to the preregulated voltage to generate an output voltage and comprising a low dropout (LDO) buffer/regulator having a current mode error amplifier driving a power transistor.

17. The voltage regulator circuit of claim 16 wherein the preregulator circuit drive current and pass transistors are formed with LDMOS transistors, and wherein the pass transistor is used in a source follower configuration.

18. The voltage regulator circuit of claim 16 wherein the power transistor is a PMOS transistor.

19. The voltage regulator circuit of claim 18 wherein the power transistor is a PMOS transistor.

20. The voltage regulator circuit of claim 16 further comprising a diode to block a DC path between a reference voltage input and output voltage input in the error amplifier.
